(19) United States
(12) Patent Application Publication
(10) Pub. No.: US 2015/0217340 A1
(43) Pub. Date: Aug. 6, 2015

(54) VESSEL AND PUMPING APPARATUS CLEANING SYSTEM

(71) Applicant: Suriyan John LOHAVICHAN, Belmont, MA (US)

(72) Inventor: Suriyan John LOHAVICHAN, Belmont, MA (US)

(21) Appl. No.: 14/172,176

(22) Filed: Feb. 4, 2014

(51) Int. Cl. B08B 3/14

(52) U.S. Cl. CPC B08B 3/14

(57) ABSTRACT

A device and method are provided for cleaning a scrubbing article. The device and method may include a hollow vessel filled with cleaning solution and a pumping apparatus with filter modules disposed along it. The pumping apparatus may be capable of insertion in the hollow vessel. A scrubbing article may be inserted in the vessel with the pumping apparatus, which may then be pumped so as to clean the scrubbing article.

### BACKGROUND

Sponges, rags, wash mitts, and other scrubbing articles for washing vehicles often collect abrasive substances and particles such as sand and dirt during the cleaning of a vehicle. These substances can subsequently scratch the surface of the vehicle when the scrubbing article comes into contact with the vehicle.

When washing vehicles, a bucket full of soapy water is often used to rinse off a scrubbing article, such as a sponge, rag, brush, or wash mitt. This also generally serves to reapply washing substances, such as soap to the scrubbing article. However, dipping a scrubbing article in such a bucket may not adequately remove damaging substances and particles like sand and grit caught in a sponge. Even if damaging substances are removed from the scrubbing article, they may remain in the bucket, allowing for them to potentially re-collect in the scrubbing article on subsequent dips of the scrubbing article in the bucket.

### SUMMARY

In one exemplary embodiment, a scrubbing article cleaning device may be provided. The scrubbing article cleaning device may include a hollow vessel capable of retaining liquid and having an open top and a filter or cushion material disposed on the bottom of its interior. The scrubbing article cleaning device may also include a pumping apparatus having a handle connected to a top end of a pole portion and several detachable segments capable of holding filter modules. The pole portion may further have at least one hole disposed in it for ejecting water that may enter the pole portion through an open bottom end. There may also be a plug inserted along the interior of the pole portion to prevent liquid from flowing past a desired segment. The pumping apparatus may have at least one filter module disposed on the pole portion. The filter module may have two substantially rigid grates with layers of filter material disposed between them. The pole portion and filter modules may be capable of insertion into the hollow vessel.

In another exemplary embodiment, a method for cleaning a scrubbing article may be provided. The method may include providing a scrubbing article cleaning device. The scrubbing article cleaning device as described above. Next, the hollow vessel may be filled with water and a desired cleaning solution. The bottom end of the pole portion may be inserted into the hollow vessel so that the at least one filter module is disposed within the hollow vessel. A scrubbing article may be inserted into the hollow vessel with the pumping apparatus. The pumping apparatus may be pumped up and down to free dirt and particles from the scrubbing article. The scrubbing article may then be removed and the process repeated as desired.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a front elevation view of an exemplary embodiment of a scrubbing article cleaning device.

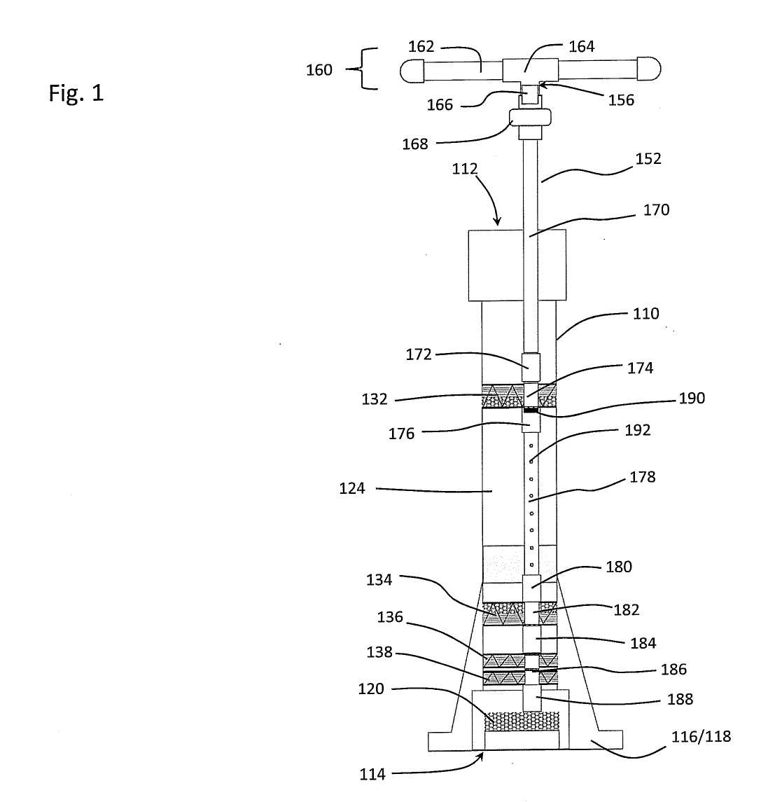

FIG. 2 is an exploded view thereof.

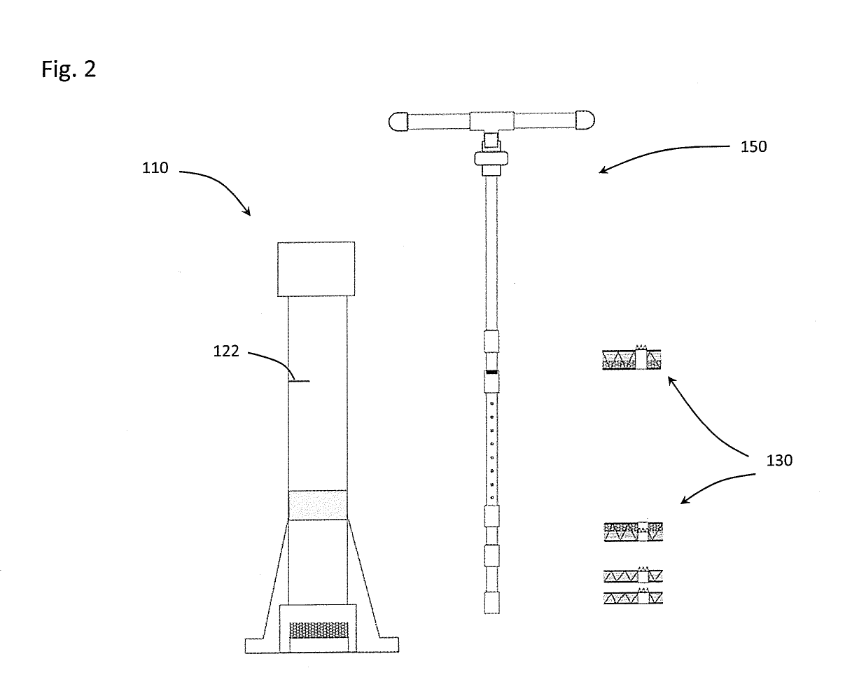

FIG. 3 is a series view thereof.

FIG. 4 is a series view with a scrubbing article.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Referring to the figures generally, a scrubbing article cleaning device may include a substantially hollow vessel 110 and a pumping apparatus 150 that may be inserted into the substantially hollow vessel 110. In an exemplary embodiment, substantially hollow vessel 110 may be a cylindrical tube. In an alternative embodiment, substantially hollow vessel 110 may be a rectangular tube. In yet other exemplary embodiments, hollow vessel 110 may be any shape as would reasonably be understood by a person having ordinary skill in the art to work in accordance with the following description. Hollow vessel 110 may have an open top end 112, a closed bottom end 114, and may be substantially elongated in a vertical direction. Hollow vessel 110 may also be able to retain water. In some embodiments, this may entail that hollow vessel 110 is made of water-tight material and that the seal of closed bottom end 114 is water-tight. Hollow vessel 110 may have a cushion material disposed within its interior, proximate bottom end 114. This may provide a cushion for the bottom of the pumping apparatus 150 during use. It also may filter dirt particles and grit near the bottom of the vessel. In an exemplary embodiment, the cushion 120 may be a piece of dense filter foam. The filter foam cushion 120 may be approximately three inches to approximately five inches in diameter. More specifically, the filter foam cushion 120 may be approximately ten centimeters in diameter. The filter foam cushion 120 may have a depth of between approximately 0.5 inches and 4 inches. More specifically, the filter foam cushion 120 may have a depth of approximately 1 inch.

In some exemplary embodiments, hollow vessel 110 may have a fill line 122 disposed on its surface to designate a fill level for water or a washing solution. The fill line 122 may be added by marker, paint or dye. Alternatively, the fill line 122 may be a strip of vinyl material attached to the interior of vessel 110. To secure the vinyl material, it may be attached with waterproof glue and further sealed with waterproof edge sealant. In yet other exemplary embodiments, fill line 122 may be created by any comparable method as would be reasonably understood by a person having ordinary skill in the art.

Hollow vessel 110 may be shaped to stand upright on its own, it may be designed with an integrated base portion or feet 116, or it may have a separate base or support 118 that may interact with it to hold it in a desired location and orientation. In one exemplary embodiment, integrated base portion or feet 116 may be foldable feet members. The foldable feet members may not only provide wider points of contact to prevent tipping, but in some embodiments, they may allow a user to stand on the feet members creating yet more stability. Alternatively, the integrated base portion or feet 116 may be rigidly mounted feet members. Rigidly deployed feet members may function similarly to the various embodiments of foldable feet members. There may be at least two feet members in embodiments with rigidly deployed or foldable feet members. In yet other exemplary embodiments, the integrated base portion or feet 116 may be a section of material, such as a flange, disposed around the bottom of vessel 110 to create a larger contact area with the surface the device is on. The base portion or feet 116 may also add weight to the bottom of vessel 110 in some embodiments to increase the stability of the device. The weight may also prevent the vessel 110 from being lifted during operation. An exemplary embodiment having a separate base or support 118 could have a cone or similar shaped object adapted to receive hollow vessel 110. An alternative embodiment could have a tripod or other support legs capable of receiving vessel 110. For embodiments having a separate base or support 118, the separate base or support 118 may function similarly to the base portion or feet 116 in that it may allow the vessel to stand upright, stabilize the vessel, and prevent the vessel from being lifted during operation.

An exemplary embodiment of vessel 110 may be assembled of a four inch PVC coupling attached to one end of a four inch (diameter) PVC pipe. However, the diameter of the pipe may vary from approximately 2 inches to approximately 24 inches. The PVC pipe may be approximately 12 to 36 inches in length. The connection between the PVC coupling and the PVC pipe may be sealed by using a waterproof silicone sealant or a PVC solvent weld. The PVC coupling end may serve as the top, open end of the vessel. A PVC threaded end cap may be joined to the end of the vessel opposite the PVC coupling. This may be threaded and sealed to the PVC pipe, creating a waterproof bottom end 114. A rubber traffic cone, which has been cut down to approximately 10 inches in height by removing a top portion of the cone, may be used as a base. The PVC pipe may be inserted into the cone and the cone may be secured to the outside of the PVC pipe with a metal pipe coupling band. The cone may be secured to the pipe so that the bottom of the cone is approximately even with the bottom of the PVC pipe, allowing the cone to function as a base support.

Pumping apparatus 150 may include a pole portion 152 and a handle portion 160. In an exemplary embodiment, handle portion 160 and pole portion 152 may be made of PVC piping. However, pumping apparatus 150 may also be made of other plastics, polymers, composites, or wood. The Handle portion 160 may extend perpendicular to pole portion 152 and may be attached at a longitudinal end of pole portion 152. Pole 152 may have at least one filter media 130 disposed along its length. The at least one filter media 130 disposed along the length of pole 152 may be shaped to substantially fill a cross-sectional area of hollow vessel 110. In an exemplary embodiment, there may be at least two filter media 130 disposed along pole 152. The at least two filter media 130 may be spaced so as to allow a scrubbing article, such as a sponge or wash mitt, to be placed between the at least two filter media 130 when inserted in vessel 110.

An exemplary embodiment of pumping apparatus 150 may be assembled out of piping, such as PVC piping. The size of pumping apparatus 150 may vary to correspond with the size of vessel 110. In some exemplary embodiments, the diameter of the piping may range from approximately 0.5 inches to approximately 12 inches. The handle portion 160 may have a cross member 162 and a joint 164 for connecting handle portion 160 to pole portion 152. Joint 164 may be a ¾ inch PVC tee with a ½ inch connector. Cross member 162 may be two 6 inch long pieces of ¾ inch PVC pipe disposed on opposite ends of a PVC tee. There may be PVC end caps on the open ends of cross member 162. In an alternative embodiment, cross member 162 may be one piece joined perpendicularly to an end of pole portion 152. Cross member 162 and pole portion 152 may be joined by a joint 164 or may be formed integrally. A top end 156 of pole portion may begin where pole portion 152 and handle portion 160 meet. Joint 164 and pole portion 152 may be connected by using a small piece 166 of ½ inch PVC pipe to connect a ½ inch PVC union joint 168. Alternatively, a ½ inch PVC female coupler could be joined to the end of the pipe. The connections may be secured by threading the pipe ends or by using pipe with pre-threaded ends. A first segment 170 of ½ inch PVC pipe may then extend between approximately 8 inches and approximately 18 inches from the joint 168. In one exemplary embodiment, the segment 170 may be approximately 13 inches long. A half inch PVC coupler 172 may then be joined to the open end of segment 170. A second segment 174 of ½ inch PVC pipe may then be attached to the open side of PVC coupler 172. Segment 174 may be between approximately 1 and 2 inches in length. More particularly, segment 174 may be approximately 1.25 inches. Segment 174 may hold a first filter module 132 disposed around it. First filter module 132 may capture particles from the water and may keep a scrubbing article in a desired area within vessel 110. The connections below coupler 172 may be separable so as to remove, replace, or wash filter modules 130. Alternative non-permanent couplings may include screw-fit couplings, PVC compression couplings, or securing a pipe within a coupling by drilling a hole through the connection and putting a removable pin, screw, or bolt through the connection to secure the pieces. Coupler 176 may be disposed on the end of segment 174 opposite coupler 172. In an exemplary embodiment, all of the segments may be threaded or pre-threaded on one or more ends to secure in corresponding threaded female couplers. However, threaded connections are not required.

A plug 190 may be disposed within segment 174 or coupler 176 to prevent water flow through pipe portion 152 past segment 174. Below coupler 176 there may be a segment 178 of ½ PVC pipe between approximately 6 and approximately 12 inches long. More particularly, segment 178 may be approximately 8 inches long. Holes 192 may be drilled in segment 178, allowing water stopped by plug 190 to escape. The holes 192 may be approximately 1/16th of an inch in diameter. In one exemplary embodiment, there may be approximately 8 holes in a line with approximately 1 inch spacing. In other embodiments, there may be any desired number of holes disposed in segment 178. Holes 192 may be in a line along the longitudinal axis of segment 178, or holes 192 may be disposed around segment 178. The streams of water ejected from the holes 192 during pumping may contact a scrubbing article, dislodging dirt and grit. Holes 192 may further add to the mixing of wash solution in the water and in some embodiments may assist in creating bubbles and suds. A ½ inch PVC coupler 180 may then be removably connected to the open end of segment 178. A segment of ½ inch PVC pipe 182 between approximately 1 and approximately 2 inches may be inserted into the open side of PVC coupler 180. More particularly segment 182 may be approximately 1.25 inches and may hold a second filter module 134 disposed around it. Second filter module 134 may capture particles in the water and keep a scrubbing article in a desired area within vessel 110. Another coupler 184 and segment 186 may follow segment 182. A bottom end of pole portion 152 may be a last coupler 188. Couplers 184, 188 and segment 186 may form a third filter module area. Segment 186 may be between approximately 1 and approximately 2 inches in length, more particularly approximately 1.75 inches in length.

Filter modules 130 may include various filter materials based on differing situations. For example, a user may desire a different filter set up based on the type of dirt, gravel, snow, salt, etc. that the vehicle may have contacted. Exemplary filter materials may include plastic grids or grates, micron rated felt filter material, and thin film composites. Filter modules 130 may include a variety of alternative filter materials including but not limited to polyester, polypropylene, aramid, nylon, rayon, viscose, and acrylic. The materials may be in sheet form, or the filter material may also be pleated, stringwound, polyspun, or comparably formed to function as substantially as described. The filter materials may be cut or shaped to create a shape substantially similar to a cross section of vessel 110. In an exemplary embodiment, this may be a circle with a diameter of approximately 10 centimeters. The size and shape of the filter modules 130 may correspond to the size and shape of vessel 110 for different embodiments.

In an exemplary filter, a plastic grid material may be disposed around layers of micron felt material. The plastic grid material may provide rigidity to the filter modules 130, preventing the modules from bending under the pressure and force applied when pumping through the water. The plastic grid material may not only trap coarse particles, but it may also come in contact with the scrubbing article that is being washed, loosening dirt and grime from the material of the scrubbing article. The grid material may be plastic hardware cloth with 0.5 inch grates. An alternative embodiment may include plastic discs with holes disposed through them. More particularly the plastic discs may be cut to approximately a four inch diameter and may have 0.25 inch holes drilled in them. The holes may allow water to flow through the discs, while still providing rigidity to the filter module.

The layers of micron felt filter material may vary in coarseness. The layers may be arranged so the coarsest layer is proximate a scrubbing article disposed between the first and second filter modules. This may allow for a wider size range of particles to become trapped in the filter. The coarse particles are trapped in the early layers and finer particles that are able to travel through the coarse filters are trapped by the deeper, fine filter layers. In an exemplary embodiment, the filter sheets may be ordered so that from the sheet closest to the scrubbing article wash area 124 to the furthest, the individual sheet micron ratings go 100, 50, 25, 10, 5, 1. Therefore in filter module 132 the sheets' ratings may go from top to bottom: 1, 5, 10, 25, 50, 100. In filter module 134 the sheets' ratings may go from top to bottom: 100, 50, 25, 10, 5, 1. In addition to the micron rated felt filter sheets, a layer of coarse filter material may be disposed closest to the scrubbing article wash area 124. In an exemplary embodiment, the coarse filter material may be approximately 1 inch thick. If the filter material were layered with the finest layers adjacent the scrubbing article wash area 124, the coarse particles may remain loose in the wash solution because the coarse particles may be too large to become entangled in or pass through the finer filter layers to reach the coarse layers.

The micron rated felt filter layers and the layer of coarse filter material may be bound together so that the material does not bend with the movement and pressure created by the churning water. The filter materials may be bound by monofilament line sewn throughout the filter module or the materials may be bound with an ultrasonic weld. The rigidity of the filter module may allow it to more effectively filter the water. The plastic grid layer on the top and bottom of each filter may also add rigidity to the filter modules. The third and fourth filter modules 136, 138 may include similar plastic grids enclosing layers of filter material. In an exemplary embodiment, the third filter module may have six sheets of micron rated felt filter material ordered from largest micron ratings on top to smallest on bottom. The fourth filter module, which may be disposed immediately below the third, may have six sheets of micron rated felt filter material ordered from smallest micron ratings on top to largest on bottom. This setup may allow for trapping various size particles. Since the third and fourth filter modules do not have a wash area or water between them, the outer layers are the coarsest and the inner layers are the finest filter layers. If the filter material were layered with the outer layers being the finest, the coarse particles may remain loose in the wash solution because the coarse particles may be too large to become entangled in or pass through the finer filter layers to reach the coarse layers. In an exemplary embodiment, the third and fourth modules may not have an additional layer of coarse filter material, though this may not be true for all embodiments. Similar to the first and second filter modules, the filter material of the third and fourth filter modules may be sewn together. They may be sewn together by monofilament line or similar material as would be understood by a person having ordinary skill in the art. They may also be bonded together by ultrasonic welding. The third and fourth filter modules may trap particles that escaped the first and second modules or that had settled in the bottom of vessel 110.

The filter modules 130 may be placed on pole portion 152 by cutting an incision through the filter modules and sliding them onto the desired segment of pole portion 152. In an exemplary embodiment, the incisions may be approximately ¾ inches in length and may be located approximately 1.5 cm offset from the center of the filter module. In an exemplary embodiment, the incisions may result in a crown effect on the felt material. The crowns may be used to ensure the filter modules are loaded in the appropriate orientation. The crowns may bunch together preventing the module from cleaning loading on the pole portion 152. In an exemplary embodiment, the crowns may be aligned so they are pointing to the top of the pumping apparatus 150.

In some exemplary embodiments, various segments of pumping apparatus 150 may be added, modified, or removed to produce desired affects. For example, segments with propellers or other water flow enhancers may be included along pole portion 152. In one alternative embodiment, segment 178 may have a different spray design from what was described above. For example, a replacement segment 178 may have slices for producing a different desired stream of water. A replacement segment 178 may alternatively have holes disposed in a helical pattern. Even further, a replacement segment may have a device that is moveable by the force of the water and that may change the orientation of a scrubbing article disposed in the scrubbing article wash area 124 so as to expose all surfaces of the article to water flow and the filter modules. It should be appreciated that various segments of pumping apparatus 150 may be added, modified, or removed.

While exemplary embodiments described above may have utilized specific materials and dimensions, such as four inch PVC pipe, they should not be read as limiting. Embodiments referenced throughout the detailed description may be made from a variety of materials including other plastics, polymers, rubbers, or composites. More specifically, materials may include Acetal, Polypropylene, High Density Polyethylene (HDPE), Polycarbonate, Acrylonitrile Butadiene Styrene (ABS), Polycarbonate/ABS Alloy, Polybutylene Terephthalate, Polybutylene, and Polyethylene Terephthalate, glass-filled Acrylic. Metals may also be used, though the use of metals may cause undesired chemical reactions with water and cleaning solutions. The various parts may also be sized appropriately to wash a desired article within the washing area.

In operation, an exemplary embodiment of a scrubbing article cleaning device may function substantially as follows. A user may fill a hollow vessel 110 with water, soap and water, or a desired cleaning solution. The user may fill the hollow vessel to a designated fill line or to a desired level. The user may then insert a pumping device 150 into the hollow vessel such that the filter media disposed on the pumping device are submerged in the liquid filling the hollow vessel. Alternatively, the user may fill the hollow vessel when the pumping device has already been inserted. If the liquid needs to be disturbed for any reason including to mix the solution or to create suds, the user may pump the pumping device up and down to do so. A user may then lift the pumping device out of the hollow vessel far enough so that the user may insert a scrubbing article inside the hollow vessel, but between at least two of the filter media disposed on the pumping device. This may keep the scrubbing article within a space defined by the sidewall of the hollow vessel and by a filter of the pumping device on the top and bottom. Once a scrubbing article has been inserted, the user may pump the pumping device in a manner allowing the scrubbing article to move through the liquid and interact with the filter media, cleaning the scrubbing article of dirt and grit. Pressure may be generated by the downward force of the filter modules against the sides of the vessel. This pressure may force water through the scrubbing article, freeing abrasive particles and grit from the scrubbing articles and forcing them into the surrounding filter media, which may trap them. As the device is pumped, bubbles and suds may be generated from the washing solution. The scrubbing article may be removed from the vessel after a desired period and used to wash a surface, such as a vehicle. If bubbles and suds are generated during the pumping process, they may transfer on the scrubbing article and eventually to the surface to be cleaned by the scrubbing article. The bubbles and suds may aid in lifting dirt from the surface to be cleaned, improving the effectiveness of the scrubbing article and washing process. The process for cleaning the scrubbing article and preparing it for further use may be repeated as desired.

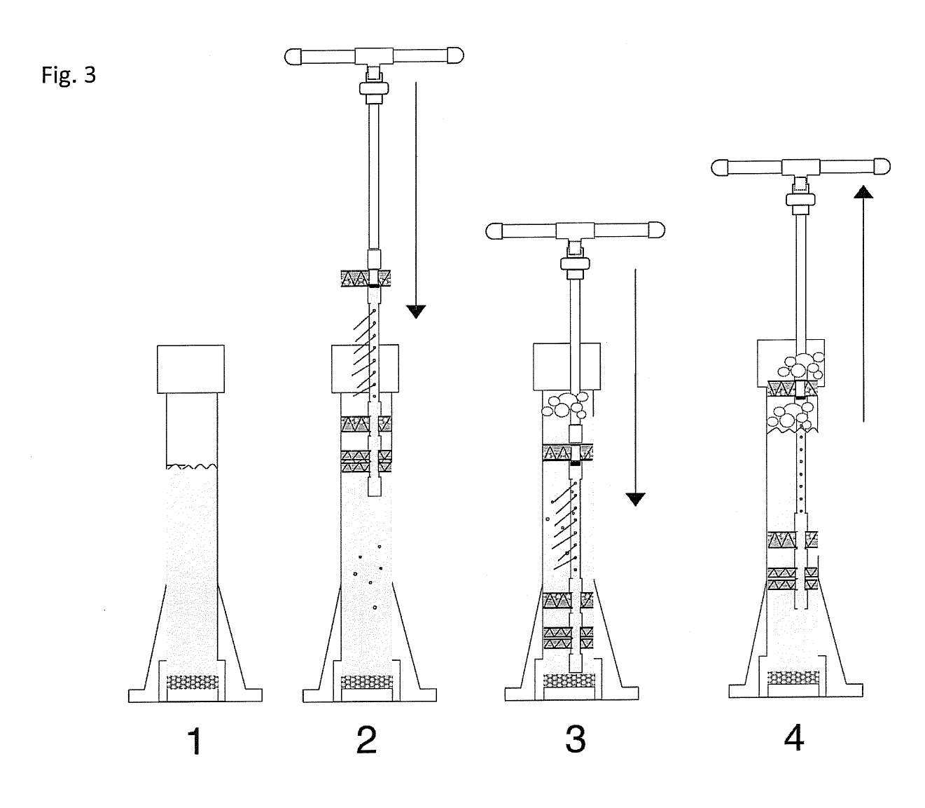

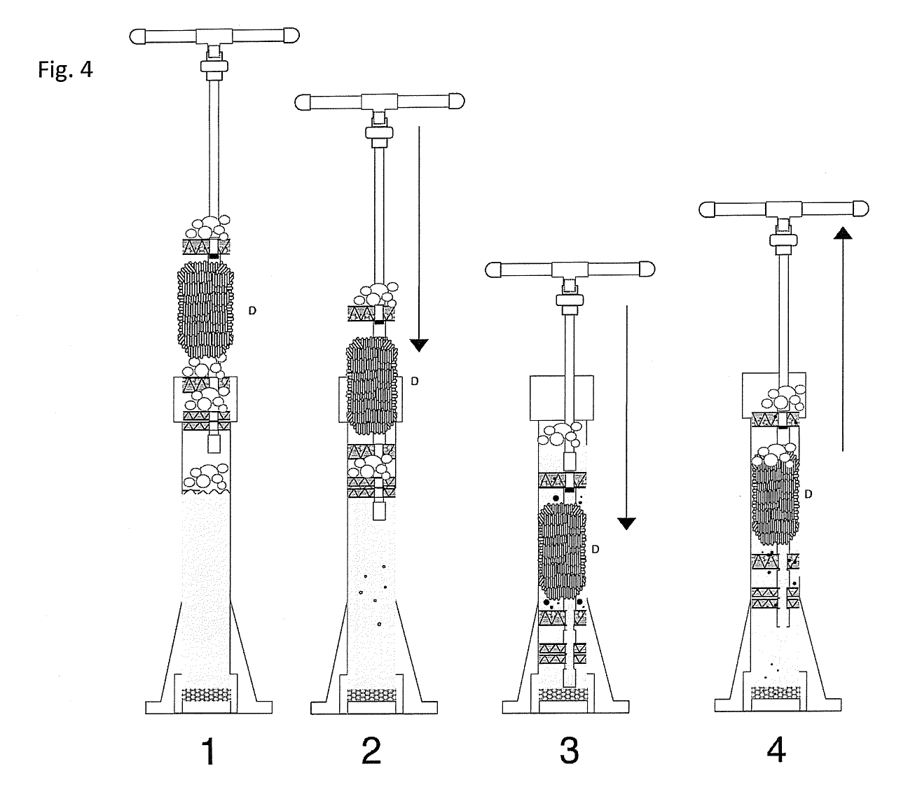

FIGS. 3 and 4 may substantially depict the operation of an exemplary embodiment of a scrubbing article washing device, as described above. FIG. 3 may show in series how the pumping apparatus may be inserted and pumped within the vessel. FIG. 4 may show the operation with a scrubbing article disposed within the device.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A scrubbing article cleaning device comprising:
a hollow vessel capable of retaining liquid and having an open top and at least one of a filter and a cushion material disposed on a bottom portion of its interior;
a pump having a handle connected to a top end of a pole portion, a plurality of detachable segments capable of holding filter modules, at least one hole along the pole portion for ejecting water that enters an open bottom end of the pole portion, and a plug that prevents liquid from flowing past a desired segment; and
at least one filter module disposed on the pole portion of the pump, the at least one filter module having at least two substantially rigid grates with layers of filter material disposed between the plastic grates;
wherein the pole portion and filter modules are capable of insertion into the hollow vessel.

2. The scrubbing article cleaning device of claim 1, further comprising at least one of a base portion and a separate support member.

3. The scrubbing article cleaning device of claim 1, wherein the at least one filter module comprises two circular plastic grids on a top and a bottom of a layer of coarse filter material and at least six sheets of felt filter material arranged in order of micron rating.

4. The scrubbing article cleaning device of claim 3, further comprising at least two filter modules disposed along the pole portion of the pumping apparatus.

5. The scrubbing article cleaning device of claim 4, wherein the at least two filter modules are situated so a first and second filter module have a space between them which defines a scrubbing article wash area, and within the scrubbing wash area a scrubbing article is disposed when the pole portion of the pumping apparatus is inserted in the hollow vessel.

6. The scrubbing article cleaning device of claim 5, wherein the at least first and second filter modules have layers of filter material arranged in order of coarseness, wherein the coarsest layer proximate the wash area.

7. The scrubbing article cleaning device of claim 5, further comprising at least a third and fourth filter module disposed along the pole portion below the first and second filter modules.

8. A scrubbing article cleaning system, comprising:
a scrubbing article cleaning device having a hollow vessel capable of retaining liquid and having an open top and at least a filter or cushion material disposed on a bottom of its interior;
a pump having a handle connected to a top end of a pole portion, several detachable segments capable of holding filter modules, at least one hole along the pole portion for ejecting water that may enter an open bottom end of the pole portion; and
a plug that prevents water from flowing past a desired segment, at least one filter module disposed on the pole portion of the pumping apparatus having two substantially rigid grates with layers of filter material disposed between the plastic grates, wherein the pole portion and filter modules are capable of insertion into the hollow vessel.

9. A method for cleaning, comprising:
filling a hollow vessel with one of water or a cleaning solution;
inserting a bottom end of a pole portion into the hollow vessel;
allowing at least one filter module to be disposed within the hollow vessel;
inserting a scrubbing article into the hollow vessel with a pumping apparatus;
pumping the pumping apparatus up and down;
disturbing and freeing dirt and particles from the scrubbing article; and
removing the scrubbing article.

10. The method of claim 9, further comprising:
standing on one of a base or support portion of a scrubbing article cleaning device formed with the hollow vessel to provide stability.

11. The method of claim 10, wherein the scrubbing article cleaning device has at least two filter modules and the at least first and second filter module have a space between them that defines a scrubbing article wash area.

12. The method of claim 11, further comprising:
inserting the pumping apparatus into the hollow vessel so that a lower of the first and second filter module is within the hollow vessel and a higher of the first and second filter module is still be above the hollow vessel;
inserting a scrubbing article into the hollow vessel above the lower of the first and second filter module, but below the higher of the first and second filter module;
inserting the pumping apparatus further so that the higher of the first and second filter module is within the hollow vessel; and
removing the scrubbing article.
